(19) United States
(12) Patent Application Publication
(10) Pub. No.: US 2020/0299897 A1
(43) Pub. Date: Sep. 24, 2020

(54) DEFIBRATION PROCESSING APPARATUS AND FIBER PROCESSING APPARATUS

(71) Applicant: SEIKO EPSON CORPORATION, Tokyo (JP)

(72) Inventor: Keigo YAMASAKI, Shiojiri (JP)

(21) Appl. No.: 16/822,118

(22) Filed: Mar. 18, 2020

(30) Foreign Application Priority Data
Mar. 20, 2019 (JP) 2019-053593

(51) Int. Cl. D21B 1/06; B02C 18/08; B02C 23/16

(52) U.S. Cl. CPC D21B 1/061; B02C 2023/165; B02C 23/16; B02C 18/08

(57) ABSTRACT

A defibration processing apparatus includes: an input port into which a raw material is input; a rotating body that rotates about a rotary shaft; a stationary member that covers at least part of the rotating body; and a discharge port through which a defibrated object obtained by the rotating body and the stationary member defibrating the raw material is discharged, in which the rotating body has a plurality of rotating blades protruding in a direction away from the rotation center shaft, and the stationary member has a configuration in which a screen having a plurality of openings is disposed in at least part of the stationary member in a direction of the rotation center shaft and surrounds the rotating body in a rotation direction.

The present application is based on, and claims priority from JP Application Serial Number 2019-053593, filed Mar. 20, 2019, the disclosure of which is hereby incorporated by reference herein in its entirety.

### BACKGROUND

### 1. Technical Field

The present disclosure relates to a defibration processing apparatus and a fiber processing apparatus.

### 2. Related Art

In the related art, in a defibration processing apparatus and a fiber processing apparatus, a raw material is introduced from an introduction port, is defibrated by an inner blade provided on an outer periphery of a rotating body and an outer blade provided on an inner periphery of a stationary member, and is discharged from a discharge port. For example, in JP-A-2015-74848, defibration is performed with the inner blade of the rotating body disposed between the introduction port and the discharge port in a rotation axis direction and the outer blade of the stationary member covering the entire rotating body in the rotation axis direction.

In a technology disclosed in JP-A-2015-74848, a defibrated object is discharged from the discharge port after passing through an entire space between the rotating body and the stationary member in the rotation axis direction. Therefore, there is a problem in that it is difficult to efficiently discharge the defibrated object. Further, there is a problem in that when there are many parts where the inner blade of the rotating body and the outer blade of the stationary member face each other, noise is likely to increase during operation of the apparatus.

### SUMMARY

According to an aspect of the present disclosure, there is provided a defibration processing apparatus including: an input port into which a raw material is input; a rotating body that rotates about a rotation center shaft; a stationary member that covers at least part of the rotating body; and a discharge port through which a defibrated object obtained by the rotating body and the stationary member defibrating the raw material is discharged, in which the rotating body has a plurality of rotating blades protruding in a direction away from the rotation center shaft, and the stationary member has a configuration, in which a screen having a plurality of openings is disposed in at least part of the stationary member in a direction of the rotation center shaft and surrounds the rotating body in a rotation direction.

In the defibration processing apparatus, the screen may be disposed to surround an entire periphery of the rotating body.

In the defibration processing apparatus, the stationary member may include a fixed blade on a surface facing the rotating body in a portion where the screen is not provided.

The defibration processing apparatus may further include a discharge path communicating with the discharge port and provided on a side of the stationary member opposite to the rotating body.

In the defibration processing apparatus, the screen may be formed of a punched metal plate.

In the defibration processing apparatus, the screen may be formed of a cylindrical punched metal plate or a coupling body obtained by combining a plurality of arc-shaped punched metal plates in the rotation direction of the rotating body.

The defibration processing apparatus may further include a gas introduction port through which gas is introduced into the defibration processing apparatus and which is formed on a side of the stationary member opposite to the rotating body separately from the input port and the discharge port.

In the defibration processing apparatus, the discharge port may be open at a position corresponding to the screen, and the rotating body may be disposed between the discharge port and the gas introduction port.

The defibration processing apparatus may further include an air feeding device that feeds the gas and is coupled to the gas introduction port.

According to another aspect of the present disclosure, there is provided a fiber processing apparatus including: the defibration processing apparatus according to the aspect; and a processing portion that processes the defibrated object defibrated by the defibration processing apparatus.

### BRIEF DESCRIPTION OF THE DRAWINGS

FIG. 1 is a perspective view of a defibration processing apparatus.

FIG. 2 is a perspective view of a stationary member.

FIG. 3 is a sectional view taken along line III-III of FIG. 1.

FIG. 4 is a cross-sectional view taken along line IV-IV of FIG. 1.

FIG. 5 is a perspective view of a stationary member according to a second embodiment.

FIG. 6 is a sectional view of a defibration processing apparatus along an axial direction according to the second embodiment.

FIG. 7 is a sectional view of a defibration processing apparatus along an axial direction according to a third embodiment.

FIG. 8 is a cross-sectional view of the defibration processing apparatus along a radial direction according to the third embodiment.

FIG. 9 is a cross-sectional view of a defibration processing apparatus along a radial direction according to a fourth embodiment.

FIG. 10 is a sectional view of a defibration processing apparatus along an axial direction according to a fifth embodiment.

FIG. 11 is a schematic view illustrating a configuration of a sheet manufacturing apparatus.

### DESCRIPTION OF EXEMPLARY EMBODIMENTS

Hereinafter, exemplary embodiments of the present disclosure will be described in detail with reference to the drawings. Embodiments described below do not limit the content of the present disclosure described in the appended claims. Further, all of configurations described below are not essential constituent requirements of the present disclosure.

### 1. First Embodiment

### 1-1. Configuration of Defibration Processing Apparatus

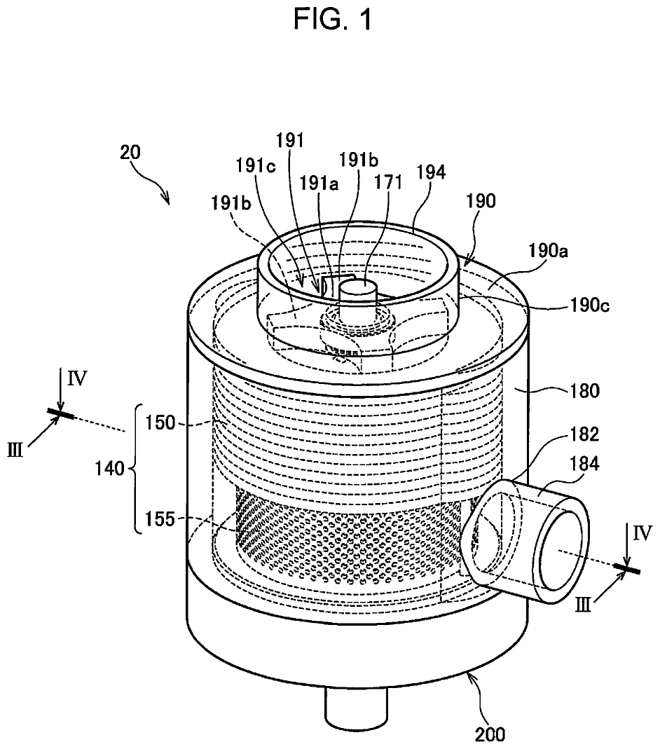

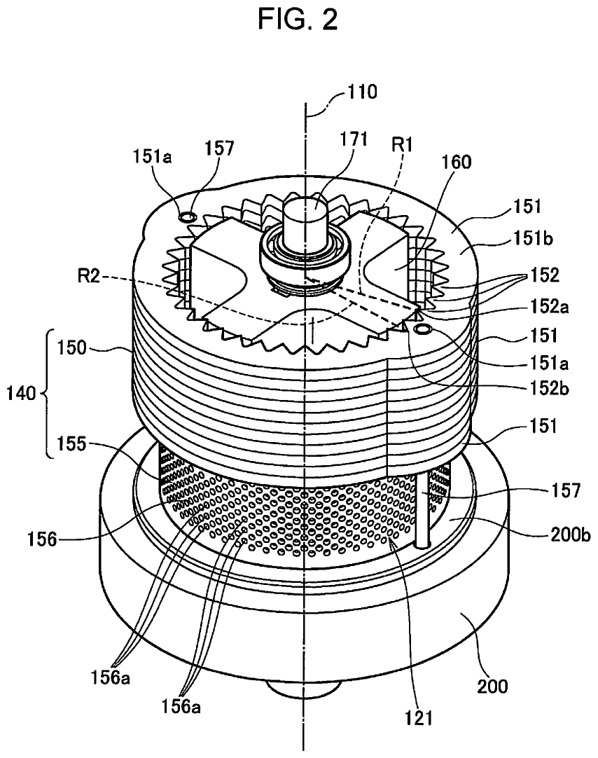

FIG. 1 is a perspective view of a defibration processing apparatus 20. FIG. 2 is a perspective view of a stationary member 140. FIG. 2 corresponds to a perspective view in which a housing 180 and an upstream cover 190 are omitted from FIG. 1.

The defibration processing apparatus 20 is an apparatus that performs processing of unwinding a raw material MA, in a state in which a plurality of fibers are bound to each other, into one or a small number of fibers. The defibration processing apparatus 20 is a dry defibration processing apparatus that performs processing such as defibration not in a liquid but in a gas such as the atmosphere and air.

As illustrated in FIGS. 1 and 2, the defibration processing apparatus 20 according to the present embodiment includes a rotating body 160 that rotates about a rotary shaft 171, and a stationary member 140 that covers the periphery of the rotating body 160. Further, the defibration processing apparatus 20 includes the housing 180 that covers and stores the rotating body 160 and the stationary member 140 and covers 190 and 200 that are arranged at both end portions of the housing 180.

The rotary shaft 171 corresponds to an example of a rotation center shaft.

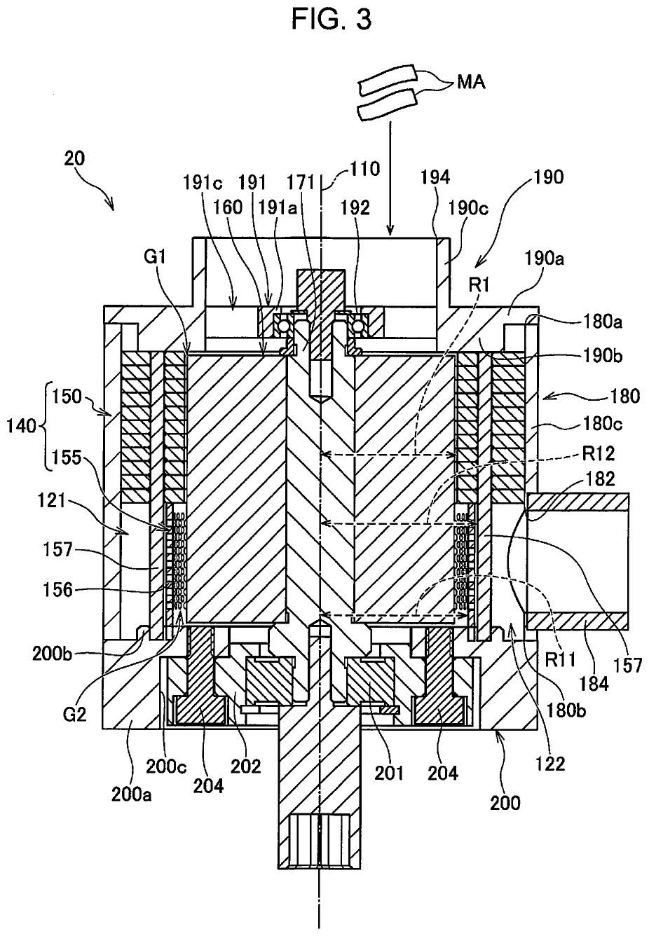

FIG. 3 is a sectional view taken along line III-III of FIG. 1.

The housing 180 of the defibration processing apparatus 20 is formed in a cylindrical shape that extends along the rotary shaft 171 of the rotating body 160. In the present embodiment, a configuration will be described in which the housing 180 and the like vertically extend according to vertical extension of the rotary shaft 171. However, the rotary shaft 171 of the rotating body 160 may be configured to extend in the horizontal direction, and accordingly, the housing 180 may also be configured to have an axial center extending in the horizontal direction. In the following description, a direction in which the rotary shaft 171 extends, that is, a direction in which the axial center of the housing 180 and the like extends, is referred to as an axial direction. Further, the center of a rotating body shape such as the rotating body 160 and the stationary member 140 in a radial direction is referred to as an axial center 110.

The upstream cover 190 is supported at one end opening portion 180a of the housing 180. The upstream cover 190 includes an annular lid portion 190a. The lid portion 190a is formed to have the same outer diameter as that of the housing 180. An annular insertion portion 190b that protrudes downward is formed below the lid portion 190a. In a state in which the insertion portion 190b is inserted into the one end opening portion 180a of the housing 180, the upstream cover 190 is fixed to the housing 180.

A cylindrical inlet pipe portion 190c extending in the vertical direction is formed at a center of the upstream cover 190 in the radial direction. The inlet pipe portion 190c communicates in the vertical direction to cause the inside and the outside of the upstream cover 190 and the housing 180 to communicate with each other. An input port 194 that is opened upward is provided at an upper portion of the inlet pipe portion 190c. The raw material MA to be defibrated is input to the input port 194.

A discharge port 182 that causes the inside and the outside of the housing 180 to communicate with each other is formed in a storage wall portion 180c on a side portion of the housing 180. The discharge port 182 discharges a defibrated object formed by the rotating body 160 and the stationary member 140 defibrating the raw material MA. An outlet pipe 184 is coupled to the discharge port 182. The outlet pipe 184 outputs, from the defibration processing apparatus 20, the defibrated object defibrated by the rotating body 160.

As illustrated in FIG. 1, a bearing support portion 191 is formed in an inner peripheral portion on the lower side of the inlet pipe portion 190c of the upstream cover 190. The bearing support portion 191 includes a circular support portion 191a and four base portions 191b extending from the support portion 191a in a cross direction. A bearing 192 that rotatably supports the rotating body 160 is supported by the support portion 191a (see FIG. 3). Further, a space 191c communicating in the vertical direction is formed between the base portions 191b, and the raw material MA input from the input port 194 can move into the housing 180 through the space 191c.

As illustrated in FIG. 3, the base cover 200 is supported by the other end opening portion 180b of the housing 180. The base cover 200 includes an annular main body portion 200a. The body portion 200a is formed to have the same outer diameter as that of the housing 180. An annular insertion portion 200b that protrudes upward is formed in the main body portion 200a. In a state in which the insertion portion 200b is inserted into the other end opening portion 180b of the housing 180, the base cover 200 is fixed to the housing 180. A bearing arrangement portion 200c that is recessed upward is formed at a center of the base cover 200 in the radial direction. A bearing 201 that supports the rotating body 160 is disposed in the bearing arrangement portion 200c via a stay 202. The stay 202 is fixed to the base cover 200 with a bolt 204.

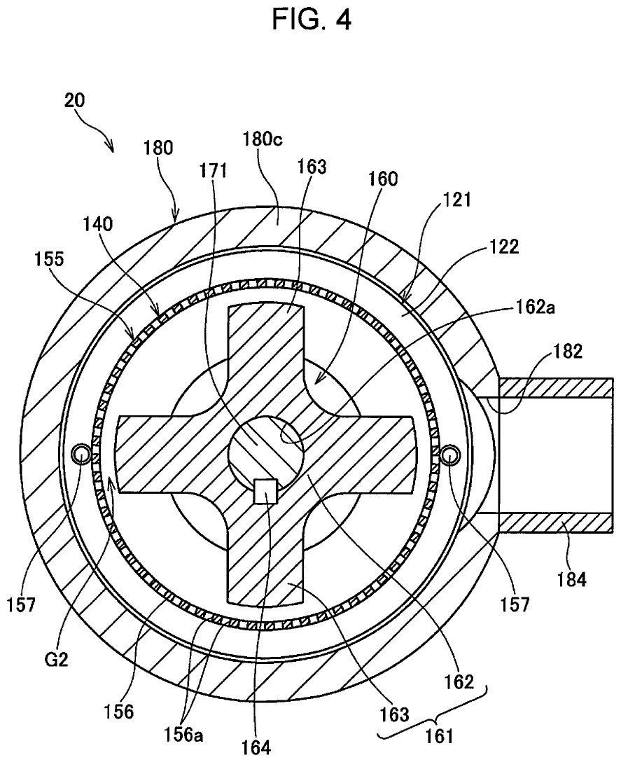

FIG. 4 is a cross-sectional view taken along line IV-IV of FIG. 1.

The rotating body 160 is disposed inside the housing 180. The rotating body 160 includes the rotary shaft 171 and a rotating body main body 161 fixedly supported by the rotary shaft 171. The rotating body main body 161 is an integrally formed block. The cross-sectional shape of the rotating body main body 161 is a cross shape. The rotating body main body 161 includes a base portion 162 having a hole 162a formed therein through which the rotary shaft 171 is inserted, and four defibration inner blades 163 that protrude radially from the base portion 162. The defibration inner blades 163 correspond to an example of a plurality of rotating blades protruding in a direction in which the rotating blades are spaced apart from the rotary shaft 171.

The rotating body main body 161 can be manufactured by, for example, casting. The rotary shaft 171 and the rotating body main body 161 are fitted in each other via a machine key 164. The rotary shaft 171 and the rotating body main body 161 can integrally rotate in a circumferential direction.

As illustrated in FIG. 3, one end side of the rotary shaft 171 is rotatably supported by the bearing 192. The other end side of the rotary shaft 171 is rotatably supported by the bearing 201.

The rotary shaft 171 is rotationally driven by a drive mechanism that is not illustrated. In the present embodiment, the drive mechanism is configured with a chain and a sprocket, and power is transmitted to the chain and the sprocket from a rotational drive source that is not illustrated, so that the rotary shaft 171 is driven. The configuration in which the rotary shaft 171 is rotationally driven may be implemented not using the chain and the sprocket.

The stationary member 140 is disposed outside the rotating body 160 in the radial direction. The stationary member 140 is a member configured in a cylindrical shape extending along the rotary shaft 171 of the rotating body 160. The stationary member 140 is concentrically disposed to cover the periphery of the rotating body 160 with gaps G1 and G2 around the rotating body 160.

The stationary member 140 according to the present embodiment includes, in the axial direction, a fixed outer blade 150 provided on the input port 194 side and a screen 155 provided on the base cover 200 side. The fixed outer blade 150 corresponds to an example of a fixed blade.

As illustrated in FIG. 2, the fixed outer blade 150 is configured by laminating a plurality of fixed plates 151. Each fixed plate 151 is a plate-shaped member. The fixed plate 151 has an annular main body portion 151b when viewed in the axial direction. Defibration outer blades 152 that protrude in a mountain shape are formed in an inner peripheral portion of the main body portion 151b in the radial direction. The defibration outer blades 152 are formed at regular intervals in the circumferential direction. The defibration outer blades 152 form an uneven shape in the circumferential direction. The fixed plate 151 can be formed by punching a cold-rolled steel plate, a steel strip, or the like with a press.

In the fixed plate 151, an inner diameter that is a distance from the axial center 110 to a top portion 152a of each defibration outer blade 152 is formed at R1. Further, an inner diameter that is a distance from the axial center 110 to a valley portion 152b between the defibration outer blades 152 is formed at R2. An unevenness difference between the top portion 152a and the valley portion 152b of the defibration outer blade 152 corresponds to a difference between the inner diameter R2 and the inner diameter R1.

The fixed plate 151 is provided with a pair of fixing holes 151a penetrated in a thickness direction. A bolt 157 extending in the axial direction is inserted through the fixing hole 151a. The bolt 157 is fixed to the insertion portion 200b of the base cover 200.

As the bolt 157 is inserted, the fixed plate 151 is positioned in the circumferential direction. The plurality of fixed plates 151 are positioned and laminated by the bolts 157, so that the fixed outer blade 150 is configured. In the present embodiment, the positions of blades of the laminated defibration outer blades 152 coincide with each other, and the top portion 152a and the valley portion 152b extend in a stripe shape in the axial direction.

The screen 155 of the stationary member 140 is provided between the fixed outer blade 150 and the base cover 200.

The screen 155 is configured by a cylindrical punched metal plate 156. Thus, the stationary member 140 has a configuration in which the screen 155 is disposed around the rotating body 160 in a rotation direction. In detail, the screen 155 is provided over one rotation (the entire one rotation) in the rotation direction. A plurality of circular hole-shaped classification ports 156a penetrated in the thickness direction are formed in the punched metal plate 156. The classification ports 156a correspond to an example of a plurality of openings.

The classification ports 156a according to the present embodiment are formed at regular intervals in the axial direction. Further, the classification ports 156a are alternately formed in the circumferential direction. The diameter of the classification ports 156a is formed according to the fiber length of the defibrated object to be classified. It is preferable that the diameter of the classification ports 156a is equal to or larger than 0.5 mm and equal to or smaller than 2.0 mm. An interval between the adjacent classification ports 156a and 156a is formed to be about the diameter of the classification ports 156a.

The punched metal plate 156 according to the present embodiment is formed of an integral punched metal plate. However, the punched metal plate 156 may be configured as, for example, a coupling body in which a plurality of arc-shaped punched metal plates are combined with each other in the rotation direction of the rotating body 160, instead of the integrated configuration.

As illustrated in FIG. 3, the punched metal plate 156 is disposed to face the discharge port 182. The punched metal plate 156 is formed such that the entire length thereof in the axial direction is longer than the diameter of the discharge port 182. The punched metal plate 156 is formed such that the inner diameter R11 of the inner peripheral surface thereof is larger than the inner diameter R2 (see FIG. 2) of the valley portion 152b of the fixed outer blade 150. The gap G2 between the rotating body 160 and the inner peripheral surface of the punched metal plate 156 is larger than the gap G1 between the rotating body 160 and the fixed outer blade 150.

The outer diameter R12 of the punched metal plate 156 is formed to be smaller than a distance from the axial center 110 to the bolt 157. The punched metal plate 156 is pinched and fixed between the fixed outer blade 150 and the base cover 200 in the axial direction. A cylindrical space 121 is formed in a portion pinched between the fixed outer blade 150 and the base cover 200 on the outside of the punched metal plate 156 in the radial direction. The space 121 communicates with a space inside the punched metal plate 156 in the radial direction via the classification ports 156a of the punched metal plate 156.

The defibrated object defibrated by the stationary member 140 and the rotating body 160 is configured to be discharged to the space 121 by the classification ports 156a of a plurality of the screens 155 provided in the axial direction.

The housing 180 is disposed on the outer peripheral side of the stationary member 140. The discharge port 182 faces the screen 155, and the space 121 communicates with the discharge port 182. A discharge path 122 communicating with the discharge port 182 is formed on a side of the stationary member 140 opposite to the rotating body 160 by the cylindrical space 121 between the screen 155 and the housing 180.

The defibrated object discharged to the discharge path 122 moves toward the discharge port 182 while riding on airflow in the discharge path 122. Then, the defibrated object is discharged from the discharge port 182 of the housing 180 to the outside of the defibration processing apparatus 20.

Here, as illustrated in FIG. 3, the input port 194 is formed on one end side of the rotary shaft 171, whereas the discharge port 182 is formed on the other end side of the rotary shaft 171 from a central portion in the axial direction. The raw material MA input from the input port 194 is configured to the defibrated while moving between the stationary member 140 and the rotating body 160 along the axial direction of the rotary shaft 171.

### 1-3. Operation of Defibration Processing Apparatus

Next, an operation of the defibration processing apparatus 20 will be described. The defibration processing apparatus 20 rotates the rotary shaft 171 to rotate the rotating body 160 and guides the raw material MA to the gaps G1 and G2 between the rotating body 160 and the stationary member 140 by the airflow, thereby dry-defibrating the raw material MA.

In the present embodiment, the raw material MA input from the input port 194 of the defibration processing apparatus 20 is introduced into the housing 180 through the inlet pipe portion 190c of the upstream cover 190. Inside the housing 180, the rotating body 160 rotates, and the raw material MA is sent to the gap G1 between the defibration inner blade 163 of the rotating body 160 and the fixed outer blade 150 of the stationary member 140. The raw material MA sent to the gap G1 flies by receiving a centrifugal force from the rotating body 160, collides with the fixed outer blade 150, and is unwound and defibrated.

Further, even in the gap G2 between the defibration inner blade 163 of the rotating body 160 and the screen 155 of the stationary member 140, the raw material MA can collide with the screen 155 and be defibrated. The raw material MA that has been defibrated and thus has a sufficiently short fiber length, that is, the defibrated object, is output from the inside of the stationary member 140 through the classification ports 156a of the screen 155 by the centrifugal force received from the rotating body 160 and the airflow. The defibrated object output from the stationary member 140 is discharged from the discharge port 182 through the discharge path 122, and is output to the outside of the defibration processing apparatus 20.

The stationary member 140 according to the present embodiment includes the fixed outer blade 150 on the input port 194 side in the axial direction and the screen 155 on the discharge port 182 side. Thus, the raw material MA that has not yet been defibrated immediately after being input from the input port 194 can be defibrated by the fixed outer blade 150, and thus the raw material MA is easily defibrated. Further, on the screen 155 on the discharge port 182 side, the defibrated raw material MA is output to the outside of the stationary member 140 through the classification ports 156a by receiving the centrifugal force from the rotating body 160 or the airflow. On the other hand, the raw material MA that is insufficiently defibrated and has a long fiber length, that is, an undefibrated object, is not output from the classification ports 156a, but is defibrated in the gap G2 between the screen 155 and the defibration inner blade 163. That is, the raw material MA can be easily output in order from the defibrated raw material MA by the screen 155 and can be classified.

In a configuration according to the related art, a rotating body is disposed between an introduction port and a discharge port in a rotation axis direction, and a defibration outer blade of a stationary member is disposed to cover the entire the outer periphery of a defibration inner blade of the rotating body in the rotation axis direction. Thus, the defibrated object is discharged from the discharge port after passing through the entire space between the rotating body and the stationary member along the rotation axis direction, regardless of a progress state of the defibration. Therefore, it is difficult to efficiently discharge the defibrated object.

Further, when an unevenness difference of the inner surface of the stationary member is large as in the defibration outer blade, fluctuation of an internal pressure when the defibration inner blade of the rotating body rotates to pass through the defibration outer blade easily increases, and the stationary member vibrates or the air vibrates, resulting in an increase in noise. Then, in this noise, as there are more portions where the defibration inner blade of the rotating body and the defibration outer blade of the stationary member face each other, the noise easily increases during an operation of the apparatus.

On the other hand, in the present embodiment, part of the stationary member 140 in the axial direction is configured with the screen 155. Therefore, as compared to a case where the fixed outer blade 150 is provided on the entire inner surface of the stationary member 140 in the axial direction, unevenness of the inner surface of the stationary member 140 is suppressed. In particular, the screen 155 is disposed in a cylindrical shape, and in a portion where the screen 155 is disposed, pressure fluctuation by the rotation of the rotating body 160 easily decreases in the entire circumferential direction. Therefore, the fixed outer blade 150 provided in the stationary member 140 is suppressed to the minimum as needed, and the screen 155 that classifies and extracts the defibrated object is provided, so that improvement in classification efficiency and improvement in quietness in the defibration processing apparatus 20 can be implemented.

As described above, the defibration processing apparatus 20 according to the present embodiment includes the input port 194 into which the raw material MA is input, the rotating body 160 that rotates about the rotary shaft 171, and the stationary member 140 that covers a lower portion as part of the rotating body 160. Further, the defibration processing apparatus 20 includes the discharge port 182 that discharges the defibrated object obtained by defibrating the raw material MA between the rotating body 160 and the stationary member 140. In the defibration processing apparatus 20, the rotating body 160 has the plurality of defibration inner blades 163 that protrude in a direction in which the defibration inner blades 163 are spaced apart from the rotary shaft 171. Further, the stationary member 140 has a configuration in which the screen 155 is disposed around one rotation of the rotating body 160 in the rotation direction in a portion of the rotary shaft 171 in the axial direction. The screen 155 is configured with the punched metal plate 156 having the plurality of classification ports 156a. Therefore, the improvement in the classification efficiency and the improvement in the quietness in the defibration processing apparatus 20 can be implemented.

Further, in the present embodiment, the stationary member 140 includes the fixed outer blade 150 in a portion where the screen 155 is not provided, that is, on a surface facing the rotating body 160 on the input port 194 side in the axial direction. Therefore, the fixed outer blade 150 is provided, so that the defibration can be more efficiently performed.

Further, in the present embodiment, the discharge path 122 communicating with the discharge port 182 is provided on a side of the stationary member 140 opposite to the rotating body 160 in the axial direction. Therefore, the defibrated object can be smoothly discharged by the discharge path 122.

Further, in the present embodiment, the screen 155 is formed of the punched metal plate 156. Therefore, the stationary member 140 can have a simple configuration, and can be made inexpensive.

Further, in the present embodiment, the screen 155 is formed of the cylindrical punched metal plate 156. Therefore, the stationary member 140 can have a simple configuration, and can be made inexpensive.

### 2. Second Embodiment

### 2-1. Configuration of Defibration Processing Apparatus

Next, a second embodiment of the present disclosure will be described. The same components as those according to the first embodiment are designated by the same reference numerals, and description thereof will be omitted.

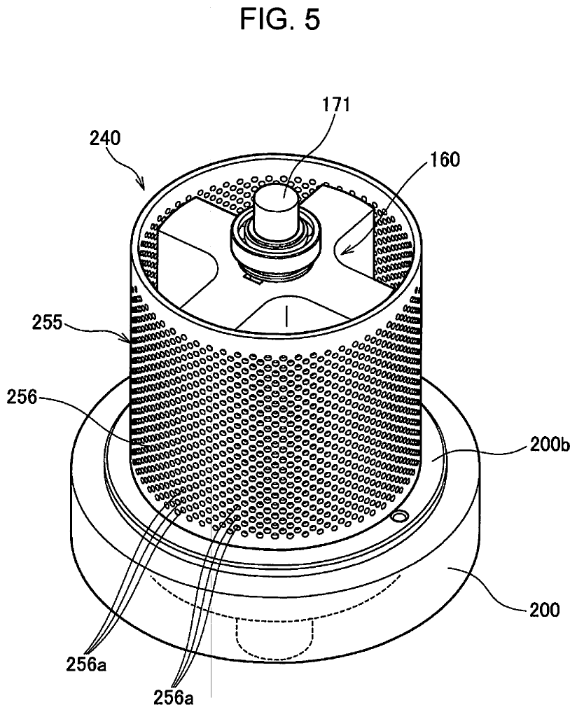

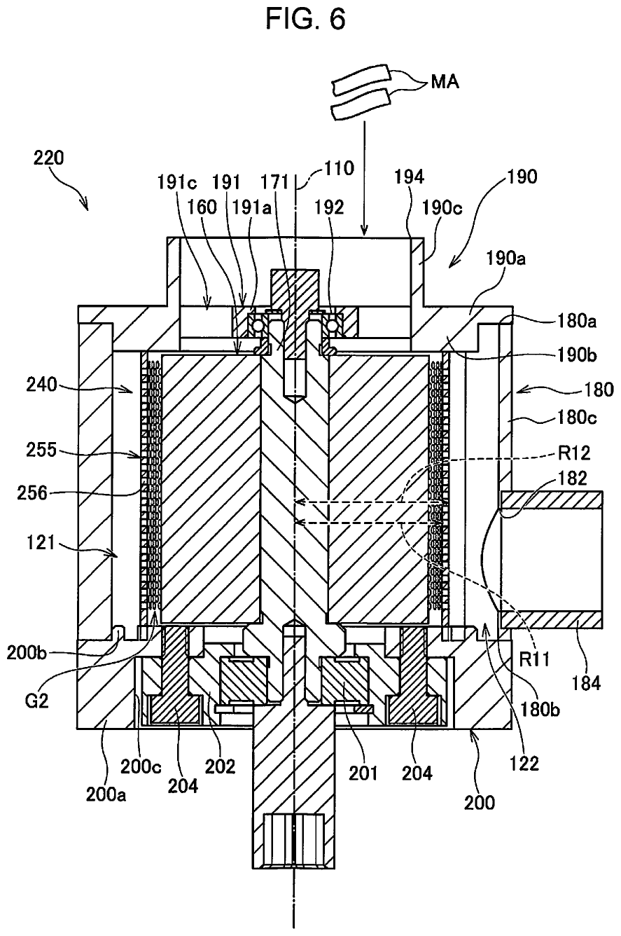

FIG. 5 is a perspective view of a stationary member 240 according to a second embodiment. FIG. 6 is a sectional view of a defibration processing apparatus 220 along an axial direction according to the second embodiment. FIG. 5 corresponds to FIG. 2 of the first embodiment, and FIG. 6 corresponds to FIG. 3 of the first embodiment.

The defibration processing apparatus 220 according to the second embodiment includes a stationary member 240 instead of the stationary member 140 according to the first embodiment. In the stationary member 240 according to the second embodiment, the fixed outer blade 150 is omitted, and the entirety thereof in the axial direction is configured with a screen 255. The screen 255 of the stationary member 240 is disposed to surround the entire periphery of the rotating body 160. The screen 255 is configured by an integral cylindrical punched metal plate 256. A plurality of classification ports 256a are formed in the punched metal plate 256. The plurality of classification ports 256a are formed over the entirety of the punched metal plate 256 in the axial direction. The punched metal plate 256 according to the second embodiment is configured in the same manner as the punched metal plate 156 according to the first embodiment except the length in the axial direction.

### 2-2. Operation of Defibration Processing Apparatus

In the defibration processing apparatus 220 according to the second embodiment, when the raw material MA is input from the input port 194 of the defibration processing apparatus 220, the raw material MA is defibrated in the gap G2 between the rotating body 160 and the stationary member 240, which is like the first embodiment. That is, in the present embodiment, while the raw material MA is defibrated in the gap G2 between the punched metal plate 256 and the rotating body 160, the defibrated object is discharged to the discharge path 122 through the classification ports 256a. In the present embodiment, the stationary member 240 does not include a defibration outer blade, and a unevenness difference on the entire inner peripheral surface of the stationary member 240 decreases. When the defibration inner blade 163 of the rotating body 160 rotates on the inner periphery of the stationary member 240, pressure vibration according to a change in an internal pressure can be suppressed in the entire axial direction, and uneven discharge of the defibrated object and occurrence of noise can be suppressed. Therefore, even in the present embodiment, by providing the screen 255 having a small unevenness difference and classifying and extracting the defibrated object, the improvement in the classification efficiency and the quietness in the defibration processing apparatus 220 can be implemented.

As described above, the defibration processing apparatus 220 according to the present embodiment includes the input port 194 into which the raw material MA is input, the rotating body 160 that rotates about the rotary shaft 171, and the stationary member 240 that covers the rotating body 160. Further, the defibration processing apparatus 20 includes the discharge port 182 that discharges the defibrated object obtained by defibrating the raw material MA between the rotating body 160 and the stationary member 240. In the defibration processing apparatus 220, the rotating body 160 has a plurality of defibration inner blades 163 the protrude in a direction in which the defibration inner blades 163 are spaced apart from the rotary shaft 171, and the stationary member 240 has a configuration in which the screen 255 is disposed around one rotation of the rotating body 160 in the rotation direction in the axial direction of the rotary shaft 171. The screen 255 is configured with the punched metal plate 256 and has the plurality of classification ports 256a. Therefore, even in the present embodiment, similar to the first embodiment, the improvement in the classification efficiency and the improvement in the quietness in the defibration processing apparatus 220 can be implemented.

Further, in the present embodiment, the screen 255 is disposed to surround the entire periphery of the rotating body 160. Accordingly, the entire periphery of the entire rotating body 160 in the axial direction is covered with the screen 255, and the entire defibration inner blades 163 face the screen 255, so that the uneven discharge of the defibrated object and the occurrence of the noise can be suppressed.

### 3. Third Embodiment

### 3-1. Configuration of Defibration Processing Apparatus

Next, a third embodiment of the present disclosure will be described. The same components as those according to the first embodiment are designated by the same reference numerals, and description thereof will be omitted.

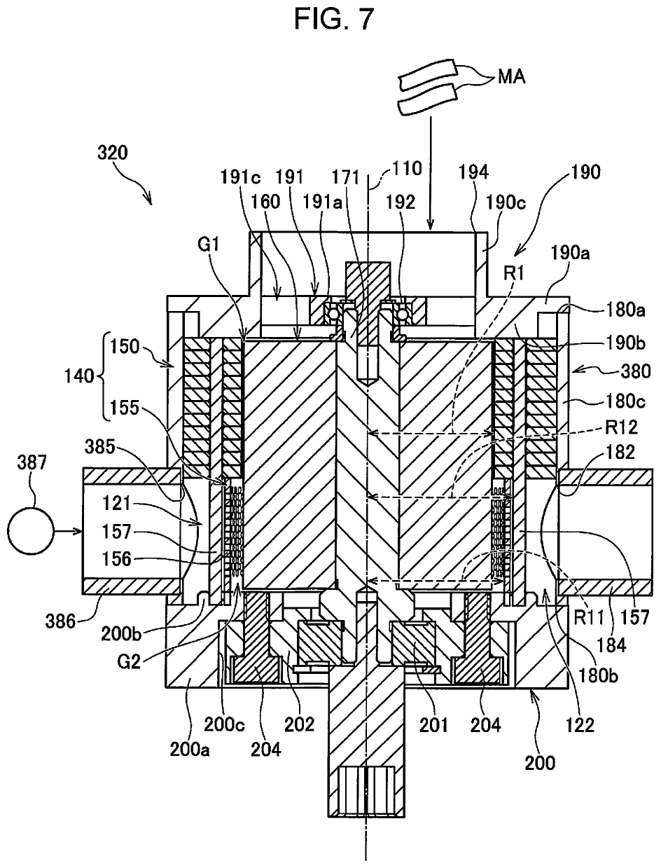

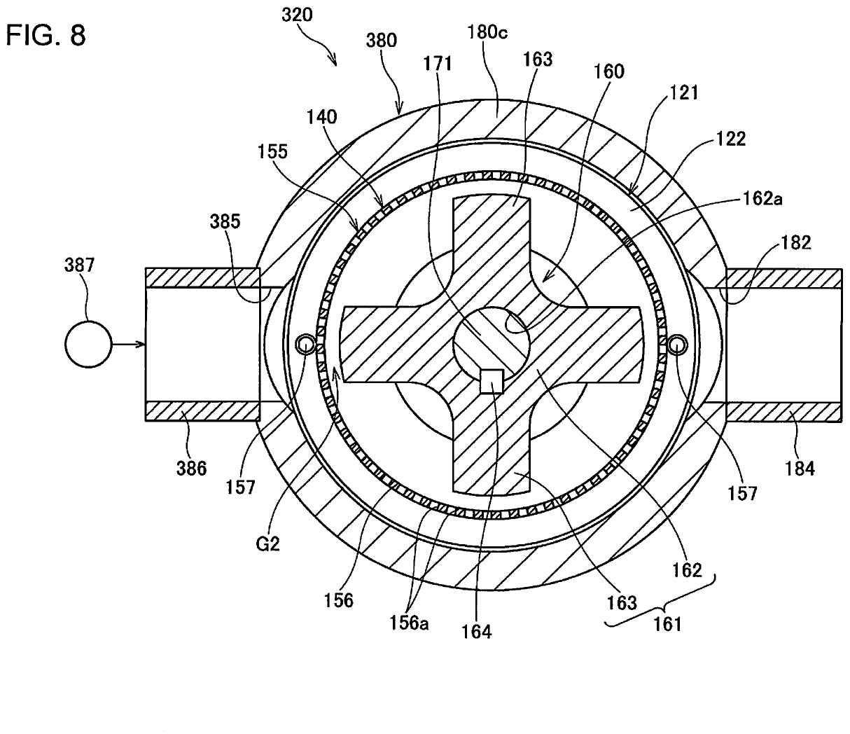

FIG. 7 is a sectional view of a defibration processing apparatus 320 along an axial direction according to the third embodiment. FIG. 8 is a cross-sectional view of a defibration processing apparatus 320 along a radial direction according to the third embodiment. FIG. 7 corresponds to FIG. 3 of the first embodiment, and FIG. 8 corresponds to FIG. 4 of the first embodiment.

The defibration processing apparatus 320 according to the third embodiment has a housing 380 instead of the housing 180 according to the first embodiment. In addition to the input port 194 and the discharge port 182, an opening-like gas introduction port 385 the causes the inside and the outside of the housing 380 to communicate with each other is formed in the storage wall portion 180c of the housing 380.

The gas introduction port 385 introduces gas into the defibration processing apparatus 320. The gas introduction port 385 is provided on a side of the stationary member 140 opposite to the rotating body 160. In the present embodiment, the gas introduction port 385 is provided outside the stationary member 140 in the radial direction, and on a side of the rotating body 160 opposite to the discharge port 182. The gas introduction port 385 is open at a position facing the screen 155. The gas introduction port 385 communicates with the discharge path 122.

The diameter of the gas introduction port 385 is formed to be equal to the diameter of the discharge port 182. A gas introduction pipe 386 is coupled to the gas introduction port 385. A blower 387 that sends gas to the gas introduction port 385 is coupled to the gas introduction pipe 386. The blower 387 corresponds to an example of an air feeding device. The blower 387 introduces the gas from the gas introduction port 385 to the discharge path 122 via the gas introduction pipe 386.

### 3-2. Operation of Defibration Processing Apparatus

In the defibration processing apparatus 320 according to the third embodiment, similar to the first embodiment, the screen 155 that classifies and extracts the defibrated object is provided. Therefore, the fixed outer blade 150 provided in the stationary member 140 is suppressed to the minimum as needed, so that the improvement in the classification efficiency and the improvement in the quietness in a defibration machine can be implemented.

Further, in the present embodiment, the gas introduction port 385 communicates with the discharge path 122, and the blower 387 is coupled to the gas introduction port 385. Thus, airflow from the gas introduction port 385 to the discharge port 182 can be applied to the discharge path 122, and the defibrated object discharged to the discharge path 122 can be discharged by the airflow from the blower 387. Further, the blower 387 is located at a position that is different from the discharge path 122, and the blower 387 is upstream of the airflow. Therefore, it is prevented that since the defibrated object flows into the blower 387, air supply capability of the blower 387 is reduced.

As described above, the defibration processing apparatus 320 according to the present embodiment includes the input port 194 into which the raw material MA is input, the rotating body 160 that rotates about the rotary shaft 171, and the stationary member 140 that covers the rotating body 160. Further, the defibration processing apparatus 320 includes the discharge port 182 that discharges the defibrated object obtained by defibrating the raw material MA between the rotating body 160 and the stationary member 140. In the defibration processing apparatus 320, the rotating body 160 has the plurality of defibration inner blades 163 that protrude in a direction in which the defibration inner blades 163 are spaced apart from the rotary shaft 171. Further, the stationary member 140 has a configuration in which the screen 155 is disposed around one rotation of the rotating body 160 in the rotation direction in a portion of the rotary shaft 171 in the axial direction. The screen 155 is configured with the punched metal plate 156 and has the plurality of classification ports 156a. Therefore, even in the present embodiment, similar to the first embodiment, the improvement in the classification efficiency and the improvement in the quietness in the defibration processing apparatus 320 can be implemented.

Further, in the present embodiment, the gas introduction port 385 through which the gas is introduced into the defibration processing apparatus 320 is provided on a side of the stationary member 140 opposite to the rotating body 160 separately from the input port 194 and the discharge port 182. Therefore, the airflow that discharges the defibrated object can be applied to the discharge path 122, and the defibrated object can be discharged efficiently.

Further, in the present embodiment, the discharge port 182 is open at a position corresponding to the screen 155, and the rotating body 160 is disposed between the discharge port 182 and the gas introduction port 385. Therefore, instead of applying the airflow from the middle of the discharge path 122, the airflow that discharges the defibrated object is applied over one rotation of the rotating body 160 in the rotation direction. Therefore, the defibrated object can be discharged more efficiently.

Further, in the present embodiment, the blower 387 that sends the gas to the gas introduction port 385 is coupled. Therefore, the blower 387 can be an upstream portion of the gas introduction port 385, and while the defibrated object is prevented from being clogged in the blower 387, the airflow can easily flow into the discharge path 122, so that the defibrated object can be efficiently discharged.

### 4. Fourth Embodiment

### 4-1. Configuration of Defibration Processing Apparatus

Next, a fourth embodiment of the present disclosure will be described. The same components as those according to the third embodiment are designated by the same reference numerals, and description thereof will be omitted.

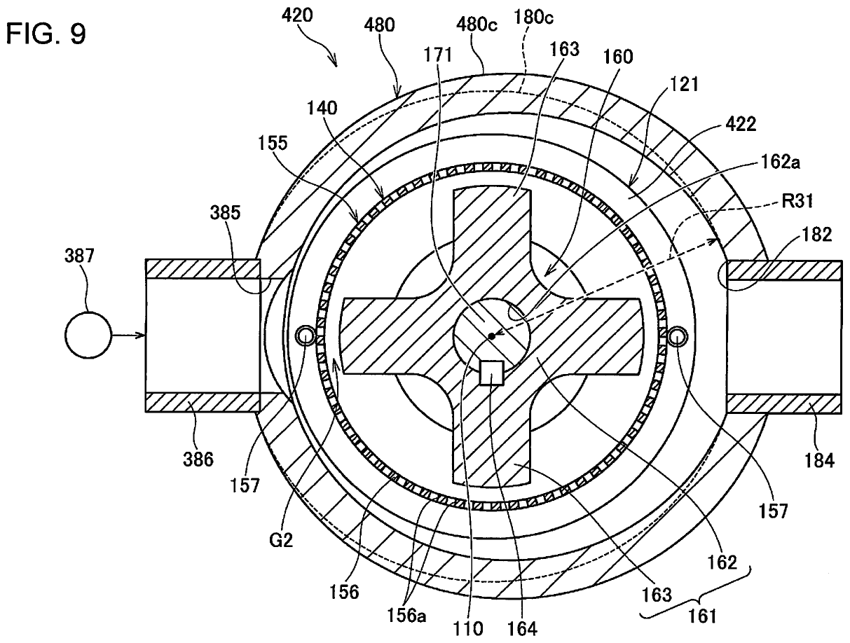

FIG. 9 is a cross-sectional view of a defibration processing apparatus 420 along a radial direction according to the fourth embodiment. FIG. 9 corresponds to FIG. 8 according to the third embodiment.

The defibration processing apparatus 420 according to the present embodiment has a housing 480 instead of the housing 380 according to the third embodiment. The storage wall portion 180c of the housing 480 according to the fourth embodiment has a bulging portion 480c formed in a portion thereof facing the screen 155. The bulging portion 480c has a shape that bulges in a radial direction with respect to the storage wall portion 180c, and bulges from the gas introduction port 385 toward the discharge port 182 in the radial direction. In detail, the diameter R31 from the axial center 110 to the inner peripheral surface of the bulging portion 480c is formed to increase from the gas introduction port 385 to the discharge port 182. A discharge path 422 is formed between the bulging portion 480c of the storage wall portion 180c and the stationary member 140. As the discharge path 422 goes from the gas introduction port 385 to the discharge port 182, the cross-section of the discharge path 422 becomes large.

### 4-2. Operation of Defibration Processing Apparatus

In the defibration processing apparatus 420 according to the fourth embodiment, when the raw material MA is input from the input port 194 of the defibration processing apparatus 420, the raw material MA is defibrated in the gaps G1 and G2 between the rotating body 160 and the stationary member 140, which is like the first embodiment. Therefore, similar to the first embodiment, the fixed outer blade 150 provided in the stationary member 140 is suppressed to the minimum as needed, and an installation ratio of the screen 155 that classifies and extracts the defibrated object increases, so that the improvement in the classification efficiency and the improvement in the quietness in the defibration machine can be implemented. Further, even in the discharge path 422 according to the fourth embodiment, similar to the discharge path 122 according to the third embodiment, the airflow for discharging the defibrated object can be applied, and the defibrated object can be efficiently discharged.

In the discharge path 422 according to the present embodiment, the cross-section thereof becomes larger from the gas introduction port 385 to the discharge port 182. The defibrated object flows into the discharge path 422 through the classification ports 156a of the screen 155. Therefore, the defibrated object in the discharge path 422 increases downstream of the discharge path 422. However, in the present embodiment in which the cross-section of the discharge path 422 becomes larger toward the discharge port 182, even when the amount of the defibrated object is large, the inside of the discharge path 422 is not easily blocked, and the airflow is easily stabilized. Therefore, the defibrated object can be efficiently discharged.

The defibration processing apparatus 420 according to the present embodiment includes the input port 194 into which the raw material MA is input, the rotating body 160 that rotates about the rotary shaft 171, and the stationary member 140 that covers the rotating body 160. Further, the defibration processing apparatus 420 includes the discharge port 182 that discharges the defibrated object obtained by defibrating the raw material MA between the rotating body 160 and the stationary member 140. In the defibration processing apparatus 420, the rotating body 160 has the plurality of defibration inner blades 163 that protrude in a direction in which the defibration inner blades 163 are spaced apart from the rotary shaft 171. Further, the stationary member 140 has a configuration in which the screen 155 is disposed around one rotation of the rotating body 160 in the rotation direction in a portion of the rotary shaft 171 in the axial direction. The screen 155 is configured with the punched metal plate 156 and has the plurality of classification ports 156a. Therefore, even in the present embodiment, similar to the first embodiment, the improvement in the classification efficiency and the improvement in the quietness in the defibration processing apparatus 320 can be implemented.

### 5. Fifth Embodiment

### 5-1. Configuration of Defibration Processing Apparatus

Next, a fifth embodiment of the present disclosure will be described. The same components as those according to the third embodiment are designated by the same reference numerals, and description thereof will be omitted.

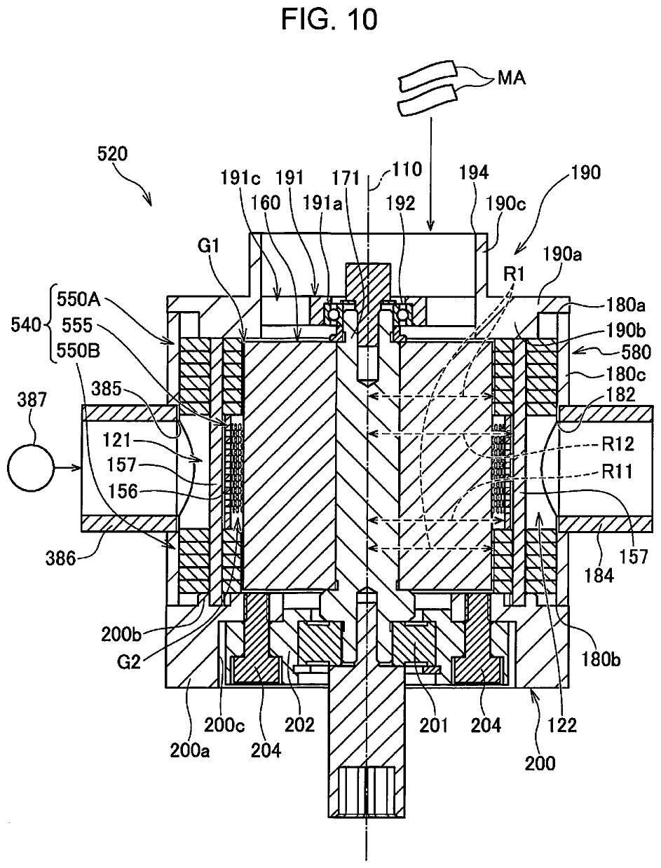

FIG. 10 is a sectional view of a defibration processing apparatus 520 along an axial direction according to the fifth embodiment. FIG. 10 corresponds to FIG. 7 according to the third embodiment.

The defibration processing apparatus 520 according to the present embodiment includes a stationary member 540 and a housing 580 instead of the stationary member 140 and the housing 380 according to the third embodiment. The stationary member 540 includes, in the axial direction, a first fixed outer blade 550A provided on the input port 194 side, a second fixed outer blade 550B provided on the base cover 200 side, and a screen 555 disposed between the first fixed outer blade 550A and the second fixed outer blade 550B.

Similar to the fixed outer blade 150 according to the first embodiment, the first fixed outer blade 550A and the second fixed outer blade 550B are configured by laminating the fixed plates 151. Further, similar to the screen 155 according to the first embodiment, the screen 555 is formed of the punched metal plate 156. The first fixed outer blade 550A and the second fixed outer blade 550B are supported by the bolts 157. Further, the screen 555 is pinched and fixed between the first fixed outer blade 550A and the second fixed outer blade 550B.

The gas introduction port 385 and the discharge port 182 are formed in the storage wall portion 180c of the housing 580. The gas introduction port 385 and the discharge port 182 are formed to face the screen 555. The housing 580 according to the fifth embodiment is the same as the housing 380 according to the third embodiment except that the formation positions of the gas introduction port 385 and the discharge port 182 are different from each other.

### 5-2. Operation of Defibration Processing Apparatus

In the defibration processing apparatus 520 according to the fifth embodiment, when the raw material MA is input from the input port 194 of the defibration processing apparatus 520, the raw material MA is defibrated in the gaps G1 and G2 between the rotating body 160 and the stationary member 540, which is like the first embodiment. That is, the stationary member 540 according to the present embodiment includes the first fixed outer blade 550A on the input port 194 side in the axial direction, the screen 155 facing the discharge port 182, and the second fixed outer blade 550B on the base cover 200 side.

Thus, the raw material MA that has not yet been defibrated immediately after being input from the input port 194 can be defibrated by the first fixed outer blade 550A, and thus the raw material MA is easily defibrated.

Further, in the screen 555 on the discharge port 182 side, the defibrated raw material MA is output to the outside of the stationary member 540 through the classification ports 156a under an action of the centrifugal force from the rotating body 160 and the airflow.

On the other hand, the undefibrated object is not output from the classification ports 156a. When the undefibrated object that is not output moves to the base cover 200 side, the undefibrated object can be defibrated in the gap G1 between the second fixed outer blade 550B and the defibration inner blade 163 of the rotating body 160. Thus, the stationary member 540 includes a screen 555 that classifies and extracts the defibrated object in the middle of the axial direction. Accordingly, the fixed outer blades 550A and 550B provided in the stationary member 540 are suppressed to the minimum as needed, so that the improvement in the classification efficiency and the improvement in the quietness in the defibration machine can be implemented.

As described above, the defibration processing apparatus 520 according to the present embodiment includes the input port 194 into which the raw material MA is input, the rotating body 160 that rotates about the rotary shaft 171, and the stationary member 540 that covers the rotating body 160. Further, the defibration processing apparatus 520 includes the discharge port 182 that discharges the defibrated object obtained by defibrating the raw material MA between the rotating body 160 and the stationary member 540. In the defibration processing apparatus 520, the rotating body 160 has the plurality of defibration inner blades 163 that protrude in a direction in which the defibration inner blades 163 are spaced apart from the rotary shaft 171. Further, the stationary member 540 has a configuration in which the screen 555 is disposed around one rotation of the rotating body 160 in the rotation direction in a central portion of the rotary shaft 171 in the axial direction. The screen 555 is configured with the punched metal plate 156 and has the plurality of classification ports 156a. Therefore, even in the present embodiment, similar to the first embodiment, the improvement in the classification efficiency and the improvement in the quietness in the defibration processing apparatus 520 can be implemented.

### 6. Sixth Embodiment

### 6-1. Entire Configuration of Sheet Manufacturing Apparatus

Next, a sixth embodiment of the present disclosure will be described. The same components as those according to the first embodiment are designated by the same reference numerals, and description thereof will be omitted.

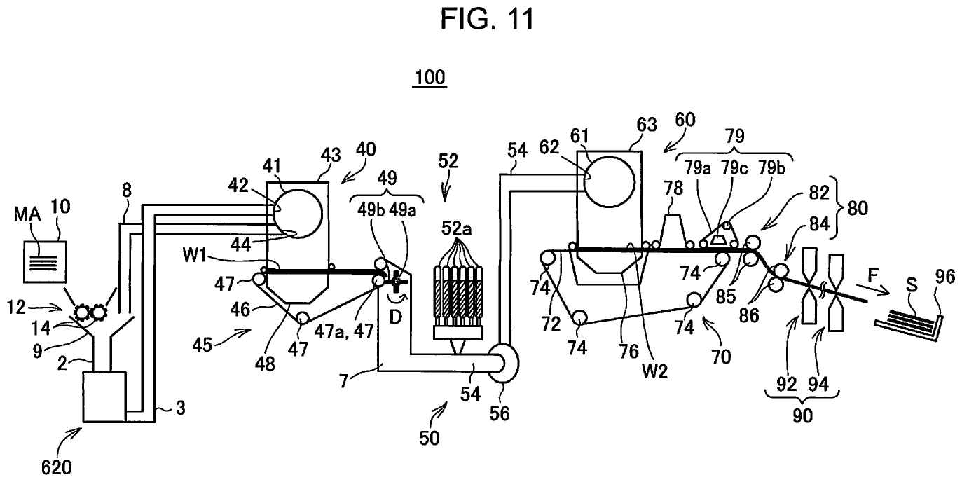

FIG. 11 is a schematic view illustrating a configuration of a sheet manufacturing apparatus 100.

The sheet manufacturing apparatus 100 executes a regeneration process in which the raw material MA containing fibers is made into a fiber and is regenerated into a new sheet S. The sheet manufacturing apparatus 100 corresponds to an example of a fiber processing apparatus.

The sheet manufacturing apparatus 100 includes a storage supply portion 10, a crushing portion 12, a defibration portion 620, a sorting portion 40, a first web forming portion 45, a rotating body 49, a mixing portion 50, an accumulation portion 60, a second web forming portion 70, a transport portion 79, a sheet forming portion 80, and a cutting portion 90.

The defibration portion 620 of the sheet manufacturing apparatus 100 is configured with the defibration processing apparatus 20 according to the first embodiment.

The sorting portion 40, the first web forming portion 45, the rotating body 49, the mixing portion 50, the accumulation portion 60, the second web forming portion 70, the transport portion 79, the sheet forming portion 80, and the cutting portion 90 correspond to examples of a processing portion that processes the defibrated object defibrated by the defibration processing apparatus, respectively.

The storage supply portion 10 is an automatic input apparatus that stores the raw material MA and continuously inputs the raw material MA to the crushing portion 12. The raw material MA preferably contains fiber and is, for example, a waste paper, a disposal paper, and a pulp sheet.

The crushing portion 12 includes a crushing blade 14 that cuts the raw material MA supplied by the storage supply portion 10, and cuts the raw material MA in the air by the crushing blade 14 to make squire strips of several centimeters. The crushing portion 12 can use, for example, a paper shredder. The raw material MA cut by the crushing portion 12 is collected by a hopper 9 and is transported to the input port 194 (see FIG. 3) of the defibration portion 620 via a pipe 2.

Crushed pieces are transported from the crushing portion 12 to the defibration portion 620 by the airflow. In the defibration portion 620, the crushed pieces are input from the input port 194, and the crushed pieces are defibrated between the rotating body 160 and the stationary member 140. The defibrated crushed pieces, that is, the defibrated object, is output through the discharge port 182. The defibrated object is transferred from the defibration portion 620 via a pipe 3 coupled to the outlet pipe 184 (see FIG. 3) to the sorting portion 40.

The sorting portion 40 sorts components contained in the defibrated object according to the size of the fiber. The sorting portion 40 has a drum portion 41 and a housing portion 43 that stores the drum portion 41. The drum portion 41 uses, for example, a sieve.

The defibrated object introduced from an introduction port 42 into the drum portion 41 is divided, through rotation of the drum portion 41, into a passing object that passes through an opening of the drum portion 41 and a residual object that does not pass through the opening. A first sorting object that is the passing object passing through the opening descends inside the housing portion 43 toward the first web forming portion 45.

Further, a second sorting object that is the residual object not passing through the opening is retransferred from the discharge port 44 communicating with the inside of the drum portion 41 via a pipe 8 to the input port 194 of the defibration portion 620.

The first web forming portion 45 includes a mesh belt 46, a stretching roller 47, and a suction portion 48. The mesh belt 46 is an endless metal belt, and is stretched around a plurality of stretching rollers 47. The mesh belt 46 orbits on a trajectory configured by the stretching rollers 47. Part of the trajectory of the mesh belt 46 is flat below the drum portion 41, and the mesh belt 46 constitutes a flat surface. The suction portion 48 corresponds to a suction mechanism.

A large number of openings are formed in the mesh belt 46. A component, which is larger than the opening of the mesh belt 46 among the first sorting object that descends from the drum portion 41 located above the mesh belt 46, is accumulated on the mesh belt 46. Further, a component, which is smaller than the opening of the mesh belt 46 among the first sorting object, passes through the opening.

The suction portion 48 includes a blower that is not illustrated, and suctions air from a side of the mesh belt 46 opposite to the drum portion 41. The component passing through the opening of the mesh belt 46 is suctioned by the suction portion 48. The airflow suctioned by the suction portion 48 attracts the first sorting object descending from the drum portion 41 to the mesh belt 46, thereby promoting the accumulation.

The component accumulated in the mesh belt 46 has a web shape, and constitutes a first web W1. Basic configurations of the mesh belt 46, the stretching rollers 47, and the suction portion 48 are the same as those of a mesh belt 72, stretching rollers 74, and a suction mechanism 76 of the second web forming portion 70, which will be described below.

The first web W1 is transported to the rotating body 49 as the mesh belt 46 moves.

The rotating body 49 includes a base portion 49a coupled to a drive portion that is not illustrated, such as a motor, and a protrusion portion 49b protruding from the base portion 49a. As the base portion 49a rotates in a direction D, the protrusion portion 49b rotates about the base portion 49a.

The rotating body 49 is located at an end portion of the planar portion of the trajectory of the mesh belt 46. Since the trajectory of the mesh belt 46 is bent downward at this end portion, the first web W1 transported by the mesh belt 46 protrudes from the mesh belt 46 and comes into contact with the rotating body 49. As the protrusion portion 49b collides with the first web W1, the first web W1 is unwound, and becomes a lump of small fibers. This lump passes through a pipe 7 located below the rotating body 49 and is transported to the mixing portion 50.

The mixing portion 50 mixes the first sorting object and additives with each other. The mixing portion 50 has an additive supply portion 52 that supplies the additives, a pipe 54 that transports the first sorting object and the additives, and a mixing blower 56.

The additive supply portion 52 supplies, to the pipe 54, the additives containing fine powder or fine particles inside an additive cartridge 52a.

The additives supplied from the additive supply portion 52 contains a resin, that is, a binder, for binding a plurality of fibers. The resin contained in the additives is melted when passing through the sheet forming portion 80, and binds the plurality of fibers.

The mixing blower 56 generates airflow in the pipe 54 that couples the pipe 7 and the accumulation portion 60 to each other. Further, the first sorting object transported from the pipe 7 to the pipe 54 and the additives supplied to the pipe 54 by the additive supply portion 52 are mixed with each other when passing through the mixing blower 56.

The accumulation portion 60 unwinds fibers of the mixture, and descends the fibers to the second web forming portion 70 while dispersing the fibers in the air. When the additives supplied from the additive supply portion 52 is in the form of fibers, these fibers are also unwound by the accumulation portion 60, and descend to the second web forming portion 70.

The accumulation portion 60 has a drum portion 61 and a housing portion 63 that stores the drum portion 61. The drum portion 61 is, for example, a cylindrical structure that is configured similarly to the drum portion 41, is rotated by power of a motor that is not illustrated similarly to the drum portion 41, and functions as a sieve.

The second web forming portion 70 is disposed below the drum portion 61. The second web forming portion 70 has, for example, the mesh belt 72, the stretching rollers 74, and the suction mechanism 76.

A component, which is larger than the opening of the mesh belt 72 among the mixture that descends from the drum portion 61 located above the mesh belt 72, is accumulated on the mesh belt 72. The component accumulated in the mesh belt 72 has a web shape, and constitutes a second web W2.

In a transport path of the mesh belt 72, a humidity control portion 78 is provided downstream of the accumulation portion 60. The humidity control portion 78 is a mist type humidifier that supplies water in the form of a mist toward the mesh belt 72. The humidity control portion 78 includes, for example, a tank that stores water, and an ultrasonic wave vibrator that makes the water into mist. Since the water content of the second web W2 is adjusted by the mist supplied from the humidity control portion 78, an effect of suppressing adsorption of fibers to the mesh belt 72 due to static electricity can be expected.

The second web W2 is peeled off from the mesh belt 72 by the transport portion 79, and is transported to the sheet forming portion 80. The transport portion 79 has, for example, a mesh belt 79a, a roller 79b, and a suction mechanism 79c. The suction mechanism 79c includes a blower that is not illustrated, and generates an upward airflow through the mesh belt 79a by a suction force of the blower. Due to this airflow, the second web W2 is separated from the mesh belt 72 and is adsorbed to the mesh belt 79a. The mesh belt 79a moves by rotation of the roller 79b, and transports the second web W2 to the sheet forming portion 80.

Similar to the mesh belt 46 and the mesh belt 72, the mesh belt 79a can be formed of an endless metal belt having an opening.

The sheet forming portion 80 applies heat to the second web W2, so that a first sorting object-derived fiber contained in the second web W2 is bound by the resin contained in the additives.

The sheet forming portion 80 includes a pressurizing portion 82 that pressurizes the second web W2 and a heating portion 84 that heats the second web W2 pressurized by the pressurizing portion 82. The pressurizing portion 82 pressurizes the second web W2 with a predetermined nip pressure by calendar rollers 85 and 85, and transports the second web W2 toward the heating portion 84. The heating portion 84 applies heat to the second web W2 densified by a pair of heating rollers 86 and 86, and transports the second web W to the cutting portion 90. In the heating portion 84, the second web W2 is heated at a temperature that is higher than a glass transition point of the resin contained in the second web W2, and thus becomes a sheet S.

The cutting portion 90 cuts the sheet S formed by the sheet forming portion 80. The cutting portion 90 includes a first cutting portion 92 that cuts the sheet S in a direction intersecting a transport direction of the sheet S as indicated by symbol F and a second cutting portion 94 that cuts the sheet S in a direction parallel to the transport direction F. The cutting portion 90 cuts the length and the width of the sheet S into a predetermined size to form a single sheet S. The sheet S cut by the cutting portion 90 is stored in the discharge portion 96.

As described above, the sheet manufacturing apparatus 100 according to the present embodiment includes the defibration portion 620, the sorting portion 40 that processes the defibrated object defibrated by the defibration portion 620, the first web forming portion 45, the rotating body 49, and the mixing portion 50. Further, the sheet manufacturing apparatus 100 according to the present embodiment includes the accumulation portion 60, the second web forming portion 70, the transport portion 79, the sheet forming portion 80, and the cutting portion 90. In the sheet manufacturing apparatus 100 according to the present embodiment, the improvement in the classification efficiency and the improvement in the quietness in the defibration portion 620 can be implemented.

The defibration portion 620 may be configured with any of the defibration processing apparatus 220, 320, 420, and 520 according to the second to fifth embodiments, instead of the defibration processing apparatus 20 according to the first embodiment.

### 7. Another Embodiment

Each of the above-described embodiments is merely a specific aspect for implementing the present disclosure disclosed in the appended claims, and does not limit the present disclosure. Further, various following aspects can be implemented within departing from the subject matter.

In the above-described embodiments, the configuration in which the rotating body 160 includes the rotating body main body 161 as a block has been described. However, the rotating body main body 161 may be configured by laminating a plurality of plates.

What is claimed is:

1. A defibration processing apparatus comprising:
an input port into which a raw material is input;
a rotating body that rotates about a rotation center shaft;
a stationary member that covers at least part of the rotating body; and
a discharge port through which a defibrated object obtained by the rotating body and the stationary member defibrating the raw material is discharged, wherein
the rotating body has a plurality of rotating blades protruding in a direction away from the rotation center shaft, and
the stationary member has a configuration, in which a screen having a plurality of openings is disposed in at least part of the stationary member in a direction of the rotation center shaft and surrounds the rotating body in a rotation direction.

2. The defibration processing apparatus according to claim 1, wherein
the screen is disposed to surround an entire periphery of the rotating body.

3. The defibration processing apparatus according to claim 1, wherein
the stationary member includes a fixed blade on a surface facing the rotating body in a portion where the screen is not provided.

4. The defibration processing apparatus according to claim 1, further comprising a discharge path communicating with the discharge port and provided on a side of the stationary member opposite to the rotating body.

5. The defibration processing apparatus according to claim 1, wherein
the screen is formed of a punched metal plate.

6. The defibration processing apparatus according to claim 1, wherein
the screen is formed of a cylindrical punched metal plate or a coupling body obtained by combining a plurality of arc-shaped punched metal plates in the rotation direction of the rotating body.

7. The defibration processing apparatus according to claim 1, further comprising a gas introduction port through which gas is introduced into the defibration processing apparatus and which is formed on a side of the stationary member opposite to the rotating body separately from the input port and the discharge port.

8. The defibration processing apparatus according to claim 7, wherein
the discharge port is open at a position corresponding to the screen, and
the rotating body is disposed between the discharge port and the gas introduction port.

9. The defibration processing apparatus according to claim 7, further comprising an air feeding device that feeds the gas and is coupled to the gas introduction port.

10. A fiber processing apparatus comprising:
the defibration processing apparatus according to claim 1; and
a processing portion that processes the defibrated object defibrated by the defibration processing apparatus.
